(19) United States
(12) Patent Application Publication
(10) Pub. No.: US 2026/0046209 A1
(43) Pub. Date: Feb. 12, 2026

(54) SERVICE MANAGEMENT AND ORCHESTRATION (SMO) BASED ARTIFICIAL INTELLIGENCE OR MACHINE LEARNING MODEL MANAGEMENT

(71) Applicant: QUALCOMM Incorporated, San Diego, CA (US)

(72) Inventors: Satashu Goel, San Diego, CA (US); Geetha Priya Rajendran, Bangalore (IN); Aziz Gholmieh, Del Mar, CA (US); Gavin Bernard Horn, La Jolla, CA (US); Rajat Prakash, San Diego, CA (US)

(21) Appl. No.: 18/797,702

(22) Filed: Aug. 8, 2024

(51) Int. Cl. H04L 41/12; H04L 41/0823; H04L 41/16

(52) U.S. Cl. CPC H04L 41/12; H04L 41/0823; H04L 41/16

(57) ABSTRACT

Management of an artificial intelligence or machine learning model deployed in a network function (NF) using a service management and orchestration (SMO) is disclosed. A network node configured to operate as an SMO framework includes at least one processor. The at least one processor configures the SMO framework to identify at least one data model to manage an artificial intelligence or machine learning (AI/ML) model associated with an NF via at least one management function; receive AI/ML associated data from the NF via the at least one management function according to the data model; update a network configuration based on the AI/ML associated data; and transmit the updated network configuration to the NF to control wireless communications. Other aspects and features are also claimed and described.

### TECHNICAL FIELD

This disclosure generally relates to wireless communication systems and, more particularly, to techniques to configure service management and orchestration (SMO) for artificial intelligence or machine learning (AI/ML) model management.

### DESCRIPTION OF RELATED TECHNOLOGY

Wireless communications systems are widely deployed to provide various types of communication content such as voice, video, packet data, messaging, broadcast, and so on. A wireless multiple-access communications system may include a number of network nodes, base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, fifth generation (5G) systems which may be referred to as New Radio (NR) systems, and sixth generation (6G) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). To save network energy or use other services, the systems may include predefined components.

As the demand for mobile broadband access continues to increase, the complexity of network operations increases. Research and development continue to advance wireless communication technologies to automatically manage the network operations. A service management and orchestration (SMO) framework is an automation platform. However, due to the continued wireless communication technology advancement, it is in need to configure the SMO framework to manage AI/ML models deployed in network functions.

### SUMMARY OF DISCLOSURE

The following summarizes some aspects of this disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure provides methods, apparatuses, and computer-readable media that support service management and orchestration (SMO) configurations for artificial intelligence or machine learning (AI/ML) model management. The systems, methods and devices of this disclosure each have several innovative aspects, no single one of which is solely responsible for the desirable attributes disclosed herein.

One innovative aspect of the subject matter described in this disclosure can be implemented in a method for managing artificial intelligence or machine learning (AI/ML) models in network functions using a Service Management and Orchestration (SMO) framework. The method includes identifying, by the SMO framework, at least one data model to manage an AI/ML model associated with a Network Function (NF) via at least one management function. The method further includes receiving, by the SMO framework, AI/ML associated data from the NF via the at least one management function according to the data model. The method then involves updating, by the SMO framework, a network configuration based on the AI/ML associated data. Finally, the method includes transmitting, by the SMO framework, the updated network configuration to the NF to control wireless communications.

Another innovative aspect of the subject matter described in this disclosure can be implemented in an apparatus configured to operate as an SMO framework. The apparatus includes a processing system that includes processor circuitry and memory circuitry that stores code. The processing system is configured to cause the apparatus to perform operations corresponding to the method described above.

In some implementations, the at least one data model may comprise at least one of a configuration data model, a performance data model, or a fault data model. The configuration data model may include at least one AI/ML configuration parameter, the performance data model may include at least one AI/ML performance measurement indication, and the fault data model may include at least one AI/ML fault indication.

In some implementations, the method or apparatus may update the AI/ML configuration parameter based on the AI/ML associated data and transmit it to the NF to apply to the AI/ML model using an online model update, an offline model update, or an external framework.

In some implementations, the at least one data model may comprise an AI/ML data model that includes AI/ML configuration parameters, performance measurement indications, and fault indications.

In some implementations, the method or apparatus may receive network operation information from the NF and determine the updated network configuration based on this information as well.

In some implementations, the method or apparatus may train a second AI/ML model, retrain the existing AI/ML model, or use a different trained version of the AI/ML model based on the AI/ML associated data to determine the updated network configuration.

In some implementations, the method or apparatus may register the management function associated with the AI/ML model in a service registry of the SMO framework to be discovered by a service consumer, and manage authorization of the service consumer to access the data model.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of this disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF SUMMARY OF THE FIGURES

The accompanying figures are incorporated into and form a part of the specification to illustrate several examples of this disclosure. These figures, together with the description, explain the principles of the disclosure. The figures simply illustrate preferred and alternative examples of how the disclosure can be made and used and are not to be construed as limiting the disclosure to only the illustrated and described examples. Further features and advantages will become apparent from the following, more detailed, description of the various aspects, examples, and embodiments of the disclosure, as illustrated by the figures referenced below.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 illustrates an example of a wireless communications system that supports service management and orchestration (SMO) configurations for external functionalities in accordance with aspects of this disclosure.

FIG. 5 illustrates a block diagram showing an SMO framework including management services to control a network function (NF) and manage an artificial intelligence or machine learning (AI/ML) model deployed in the NF according to aspects of this disclosure.

FIG. 6 illustrates a block diagram showing AI/ML configuration parameters with existing parameters in a configuration data model according to aspects of this disclosure.

FIG. 7 is a sequence diagram to show management of an AI/ML model deployed in an NF using an SMO framework according to aspects of this disclosure.

FIG. 8 illustrates a block diagram showing an SMO framework including management services to control a network function and manage an AI/ML model deployed in the SMO framework according to aspects of this disclosure.

FIG. 9 illustrates a block diagram showing AI/ML configuration parameters in a configuration data model according to aspects of this disclosure.

FIG. 10 is a sequence diagram to show management of an AI/ML model deployed in an NF using an SMO framework according to aspects of this disclosure.

FIG. 11 is a sequence diagram to show management of an AI/ML model deployed in an NF using a network energy saving application of an SMO framework according to aspects of this disclosure.

FIG. 12 is a block diagram of an example network node that SMO framework configuration for AI/ML model management according to one or more aspects.

FIG. 13 illustrates a method 1300 for wireless communication at a network node according to aspects of this disclosure.

Reference is made to the figures wherein like numerals refer to like parts throughout. The figures are not necessarily to scale, and the skilled artisan will appreciate that certain feature(s) may be exaggerated for clarity, dimensioning, and ease of understanding.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

As the demand for mobile broadband access continues to increase, the complexity of network operations increases. Research and development continue to advance wireless communication technologies to automatically manage the network operations. A service management and orchestration (SMO) framework is an automation platform. However, due to the continued wireless communication technology advancement, it is in need to configure the SMO framework to manage artificial intelligence or machine learning (AI/ML) models deployed in network functions.

This disclosure addresses the need for AI/ML model management by a service management and orchestration (SMO) framework to improve wireless communications. In doing so, this disclosure provides a system or method to configure an SMO framework to manage an AI/ML model deployed in a network function (NF) via one or more existing management functions or a new management function to improve wireless communication.

One aspect of this disclosure involves an apparatus configured to operate as an SMO framework. The SMO framework identifies at least one data model to manage an AI/ML model associated with an NF via at least one management function. Then, the SMO framework receives AI/ML associated data from the NF via the at least one management function according to the data model. The SMO framework updates a network configuration based on the AI/ML associated data and transmit the updated network configuration to the NF to control wireless communications.

Particular aspects of the subject matter described in this disclosure can be implemented to realize one or more of the following potential advantages. First, an application in an SMO framework can manage both the parameters of an NF and the parameters of AI/ML models deployed in the NF. For example, the SMO framework may manage RAN parameters (e.g., antenna tilt, administrative state) and the parameters (e.g., DNN parameters) of AI/ML models deployed in the RAN. The application in the SMO framework can utilize both Network and AI/ML performance data to modify configuration parameters and improve wireless communications.

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

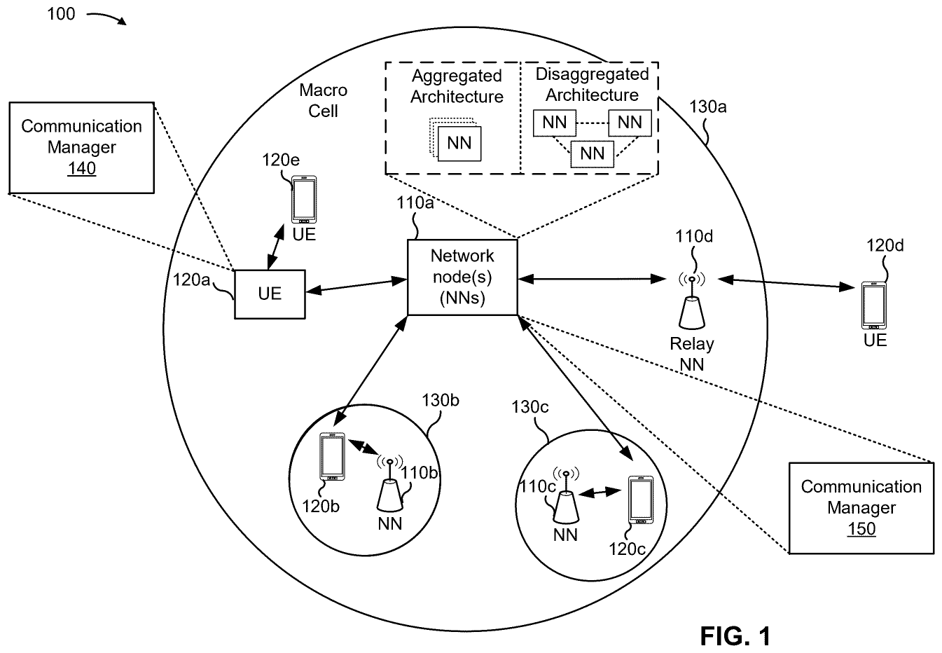

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHZ through 7.125 GHZ), FR2 (24.25 GHz through 52.6 GHZ), FR3 (7.125 GHz through 24.25 GHz), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHz, FR 1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may obtain an indication that a model, associated with at least one of encoding or decoding, is to be used in association with a control channel; output, after obtaining the indication, one or more model parameters associated with a data distribution of the control channel; encode, using an encoder, data, the encoder being associated with the one or more model parameters; and output the data for transmission via the control channel. Additionally, or alternatively, the communication manager 140 may perform one or more other operations described herein.

In some aspects, the network node 110 may include a communication manager 150. As described in more detail elsewhere herein, the communication manager 150 may output an indication that a model, associated with at least one of encoding or decoding, is to be used in association with a control channel; obtain, after obtaining the indication that the model is to be used, one or more model parameters associated with a data distribution of the control channel; obtain data associated with the control channel; and decode, using at least one of a decoder or an encoder, the data, the decoder and the encoder being associated with the one or more model parameters. Additionally, or alternatively, the communication manager 150 may perform one or more other operations described herein.

As indicated above, FIG. 1 is provided as an example. Other examples may differ from what is described with regard to FIG. 1.

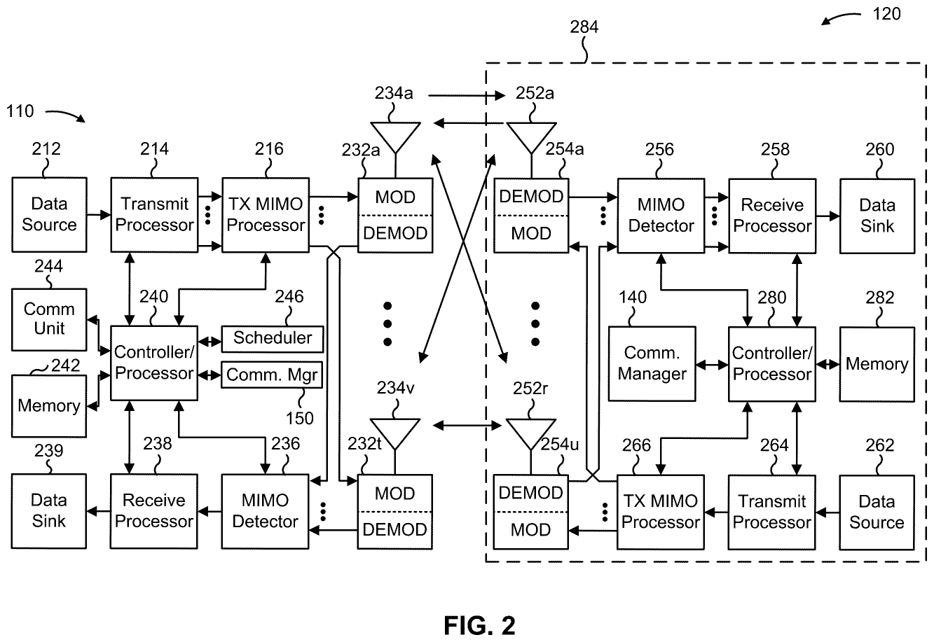

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding scheme (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

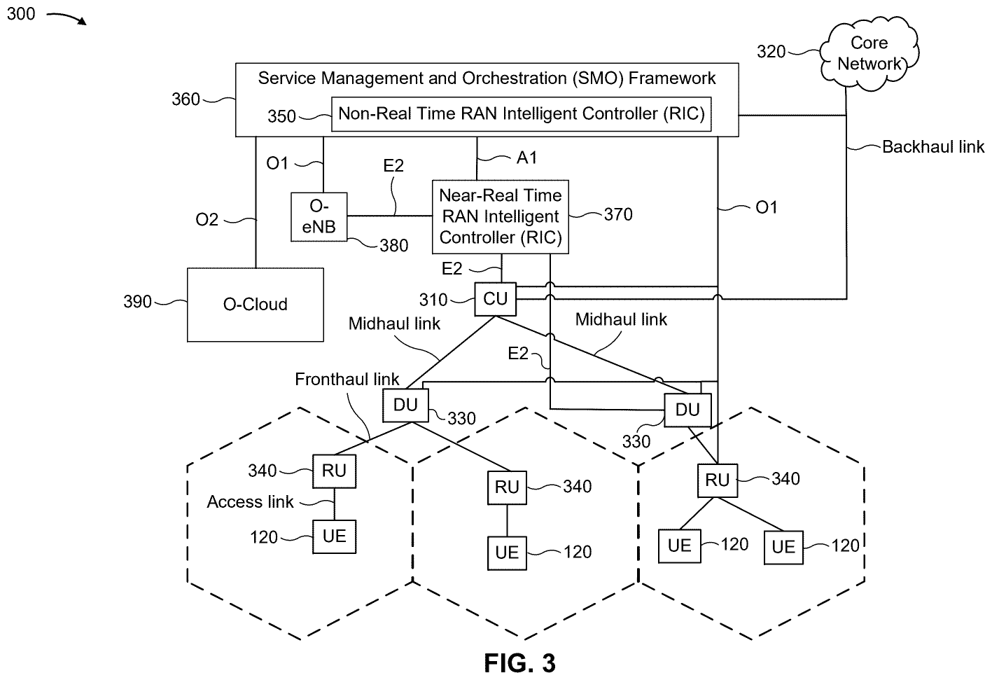

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). In some examples, for RAN, the Non-RT RIC 350 may be designed to process a task in non-real time (e.g., more than 1 second control loop) while the Near-RT RIC 370 may be designed to process a task in near-real time (e.g., less than 10 millisecond control loop). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330. In some examples, in O-RAN architecture, CU, DU and RU may have equivalent RAN nodes (e.g., O-CU, O-DU and O-RU). Also, O1 and E2 interfaces may be supported by O-RAN nodes and/or 3GPP defined nodes (e.g., CU and DU).

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture. In some examples, the O1 interface may be communicatively coupled to O-RAN NFs (e.g., the CU(s) 310 and DU(s) 330).

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

In other aspects, the SMO framework 360 may include both of the Non-RT RIC 350 and the Near-RT RIC 370. In such examples, the SMO framework 360 may have the same input and output interfaces or different input and output interfaces for the Non-RT RIC 350 and the Near-RT RIC 370. For example, an application (e.g., an energy saving application, a traffic steering application) may process tasks for the near-real time scale and the non-real time scale. When the SMO framework 360 includes the Non-RT RIC 350 and the Near-RT RIC 370, the application does not need to have additional logic or circuit to coordinate two different RICs. In such examples, the SMO framework 360 may include a single RIC or multiple RICs to operate as the Non-RT RIC 350 and the Near-RT RIC 370. In some examples, the SMO framework 360 may directly access the Near-RT RIC 370 and coordinate with the Non-RT RIC 350 and the Near-RT RIC 370. For example, the SMO framework 360 may share policies that the Non-RT RIC 350 and the Near-RT RIC 370 enforce. In further examples, the SMO framework 360 may reuse functionality for the Non-RT RIC 350 and the Near-RT RIC 370 because some functionality is duplicate across the Non-RT RIC 350 and the Near-RT RIC 370 (e.g., application management, service discovery, data discovery, data management, data collection from RAN). In some examples, the applications in SMO framework 360 may interwork with applications in Near-RT RIC without any dependence on AI interface as the application may discover and communicate with each other without a special interface. In the converged SMO framework to merge functionalities of both the time scales (e.g., non-real time and near-real time), a specific SMO framework may be configured with specific capabilities during deployment. For example, some SMO frameworks may be configured to only have Non-RT control, only have Near-RT control, or have both of Non-RT control and Near-RT control.

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with model management for control channel encoding or decoding, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1400 of FIG. 14, or other processes as described herein (alone or in conjunction with one or more other processors). In some aspects, the wireless node described herein is the network node 110, is included in the network node 110, and/or includes one or more components of the network node 110 shown in FIG. 2. Additionally, or alternatively, the wireless node described herein is the UE 120, is included in the UE 120, and/or includes one or more components of the UE 120 shown in FIG. 2. For example, as used herein, “wireless node” refers to the network node 110 and/or the UE 120.

The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1400 of FIG. 14, or other processes as described herein. In some examples, executing instructions may include running the instructions, converting the instructions, compiling the instructions, and/or interpreting the instructions, among other examples.

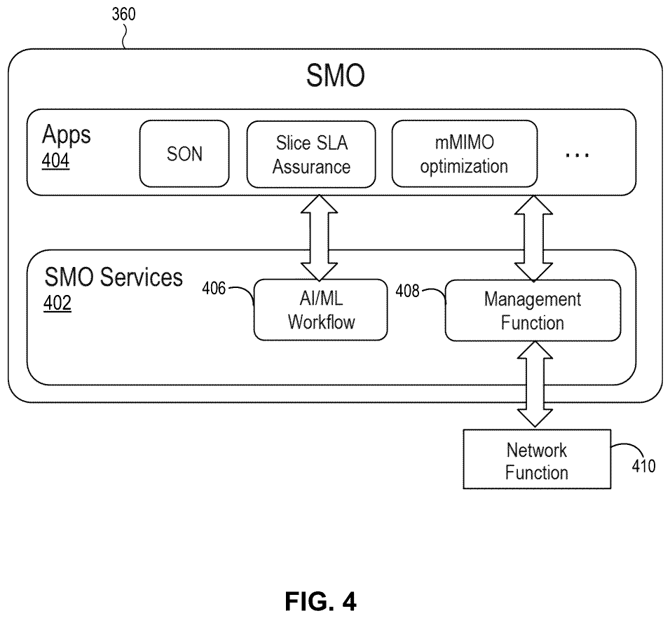

FIG. 4 illustrates a block diagram showing an SMO framework communicating with a network function according to aspects of this disclosure. The SMO framework 360 is a component to configure and manage artificial intelligence or machine learning (AI/ML) models deployed in Network Functions (NF) (e.g., RAN NFs and/or core network NFs). For example, the SMO framework 360 may collect data (measurements, configuration, fault, event stream, and/or logging) from the NFs (e.g., using the O1 interface). In an O-RAN (Open Radio Access Network) architecture, the CU, DU, and RU components shown have equivalent nodes, namely O-CU, O-DU, and O-RU respectively. These O-RAN nodes support specific functionalities, e.g., the E2 interface is supported by O-CU and O-DU. The O1 interface should be understood to terminate on both the CU (O-CU) and DU (O-DU) components. This O-RAN architecture enables more flexible and open network deployments, supporting the advanced management capabilities described in this disclosure. Additionally or alternatively, the SMO framework 360 may provide policies (e.g., for UE to change frequency) or data enrichment to the NFs (e.g., over the AI interface). The SMO framework 360 may include SMO service components 402 to provide SMO services (e.g., service management, data management, policy management, RAN analytics, service orchestration, topology & inventory, RAN NF orchestration and management, and/or AI/ML workflow). The SMO service components 402 may run on the Non-RT RIC 350 to provide various functionalities (e.g., service management, data management, RAN NF operation administration and maintenance (OAM), policy management RAN analytics, service orchestration, topology & inventory, and/or AI/ML workflow). In some examples, the SMO framework 360 may include applications 404 (e.g., rApps) to maximize the network's operational efficiency. For example, the application 404 may include a third-party application to provide services to support and facilitate network optimization and operations, including policy guidance, enrichment information, configuration management and/or data analytics. The application 404 may provide services based on inferences of the AI/ML model deployed in the NF 410. The SMO framework 360 may be deployed on premises, on the cloud (e.g., telco cloud), or as-a-service to meet the end-user requirements.

In some examples, the SMO framework 360 may include the AI/ML workflow component 406 to manage AI/ML workflow. For example, the AI/ML workflow component 406 may manage model registry, model training, model deployment and inference, model monitoring, model update/rollback, A/B testing, and/or canary deployment.

In some examples, the SMO framework 360 may communicate with an NF 410 using a management function 408 to manage an AI/ML model deployed in the NF. The NF 410 may provide one or more services to other NFs in the network and make available over an application programming interface (API). For example, the NF may include a network function of the RAN (e.g., the CU 310 in FIG. 3, the DU 330 in FIG. 3, the RU 340 in FIG. 3, or any other suitable NFs to control connectivity and data transfer in the RAN). In other examples, the NF may include any suitable NF in the core network 320 in FIG. 3. The NF 410 may be deployed on the same platform as the SMO framework 360 or on a dedicated hardware with software platform for the RAN or core network, which is separate from the platform for the SMO framework 360.

In some examples, the management function 408 of the SMO service components 402 may interconnect between the application 404 and the NF 410. For example, the management function 408 may manage the AI/ML model deployed in the NF 410 by updating the AI/ML model and/or monitoring the performance of the AI/ML model. In some examples, the management function 408 in the SMO framework 360 may be communicatively coupled to a management function of the NF 410 where the management function of the NF 410 is implemented as part of the NF 410. The SMO framework 360 may collect data (e.g., measurements, configuration of the current configuration of the NFs, any fault data, event streams or logging information), and based on the data, the SMO framework 360 may update the configuration of the AI/ML model deployed in the NF 410 and configure the NF 410 to control the wireless communications by providing configuration or policy to the NF 410.

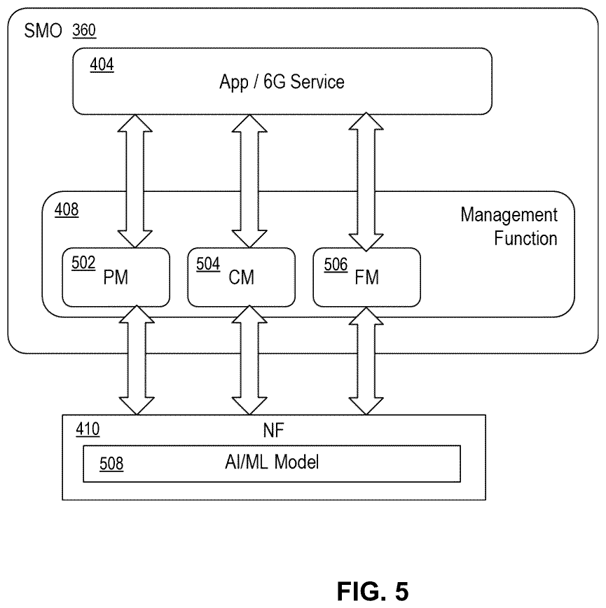

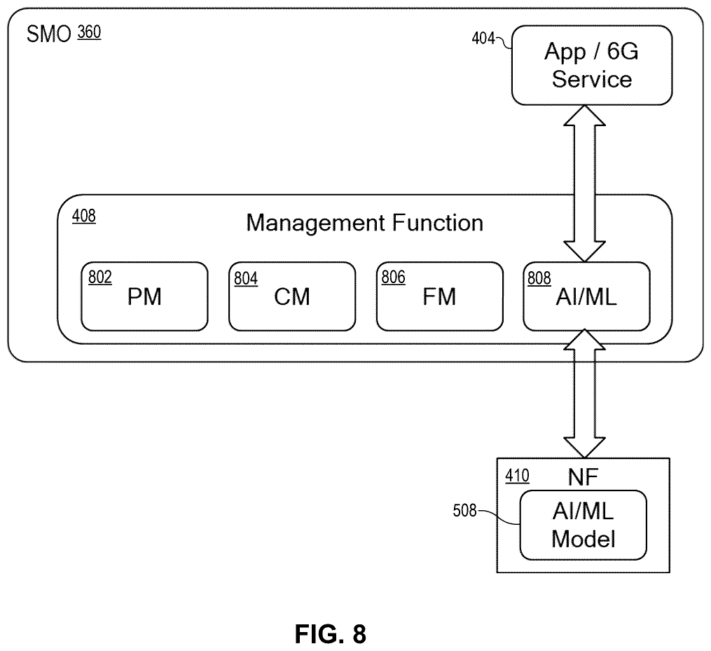

In some examples, the SMO framework 360 may be configured in various ways to manage AI/ML models deployed in the NF 410. In some examples, the SMO framework 360 may utilize management functions (e.g., configuration management service, performance management service, and/or fault management service) to manage AI/ML models deployed in the NF 410, by extending the information and data models used in management services. FIGS. 5-7 are described such examples. In other examples, the SMO framework 360 may extend the management function to include a separate management service (e.g., AI/ML management service) for managing AI/ML models deployed in the network. FIGS. 8-10 are described such examples.

FIG. 5 illustrates a block diagram showing an SMO framework including management services to control an NF and manage an AI/ML model deployed in the NF according to aspects of this disclosure. For example, the management function 408 may include performance management 502 using a performance data model, configuration management 504 using a configuration data model, and/or fault management 506 using a fault data model. In some examples, the performance management 502, the configuration management 504, and the fault management 506 may be existing services (e.g., defined by 3GPP Technical Specification Group Service and/or O-RAN to manage an NF). To manage an AI/ML model 508 deployed in the NF 410, the management function 408, the performance data model, the configuration data model, and the fault data model may be extended. In further examples, the existing data models may be used to manage the AI/ML model 508. For example, the procedures defined for the performance, configuration, and fault management of network may apply for the AI/ML model management. For example, the management function 408 may use the same API to retrieve AI/ML model related data according to the performance data model, the configuration data model, and/or the fault data model. The API may be an existing API for other data to retrieve or a new API for the AI/ML related data. In other examples, the management function 408 may use different APIs to retrieve AI/ML model related data according to the performance data model, the configuration data model, and the fault data model.

The performance data model may include at least one AI/ML performance measurement indication. For example, the performance data model may include at least one AI/ML performance measurement field to include the at least one AI/ML performance measurement indication. In some examples, the at least one AI/ML performance measurement field may be added to the existing performance data model. In some examples, the NF 410 and/or the AI/ML model 508 may determine the AI/ML performance measurement indication. Then, the management function 408 may retrieve the AI/ML performance measurement indication according to the performance data model from the NF 410 and/or the AI/ML model 508. The AI/ML performance measurement indication may indicate a machine learning evaluation metric that measures an AI/ML model's accuracy. The AI/ML performance measurement indication may be included in an AI/ML performance measurement category as a new category in performance measurements. For example, the AI/ML performance measurement category may be added in the existing performance data model.

The AI/ML performance measurement indication in the new category may include performance metrics related to the AI/ML model 508. The performance metrics may include a mean square error, a mean absolute error, a F1-score, a precision indication, a recall indication, a latency of inference, a throughput (number of inferences per second), an energy cost (e.g., Joules per inference), and/or any other suitable metrics. In some examples, the mean square error, the mean absolute error, the F1-score, the precision indication, and/or the recall indication may measure accuracy of inference of the AI/ML model 508. In some examples, the performance metrics may be measured on a slice of data (e.g., based on a group of cells, a group of UEs, a period of time, a network slice, a band of operation, and/or a UE measurement (e.g., Reference-Signal-Receive-Power (RSRP), Reference Signal Received Quality (RSRQ), Received Signal Strength Indicator (RSSI), Signal-to-interference-plus-noise ratio (SINR) and/or Signal to Noise Ratio (SNR)). In further examples, the latency of inference, the throughput, and/or the energy cost may measure performance of running inference of the AI/ML model 508. Thus, the accuracy of inference may measure the performance of the AI/ML model 508 while the performance of running inference of the AI/ML model 508 may measure the performance of the model deployment. In some examples, the performance data model may further include other existing performance measurement indications.

The configuration data model may include at least one AI/ML configuration parameter. For example, the configuration data model may include at least one AI/ML configuration field to include the at least one AI/ML configuration parameter. In some examples, the at least one AI/ML configuration field may be added to the existing configuration data model. In some examples, the at least one AI/ML configuration parameter may include weights, biases, at least one model architecture, at least one activation function, or any other suitable parameters. In some examples, the management function 408 may retrieve the at least one AI/ML configuration parameter according to the configuration data model from the NF 410 and/or the AI/ML model 508. The AI/ML model 508 deployed in the NF 410 may be controlled based on the at least one AI/ML configuration parameter. For example, The AI/ML model 508 may be controlled by changing the AI/ML configuration parameter of the AI/ML model 508 (e.g., updating the layers and/or weights of the AI/ML model 508). In other examples, changing the configuration of the AI/ML model 508 may including training a new AI/ML model 508 with a new configuration based on the AI/ML configuration parameter.

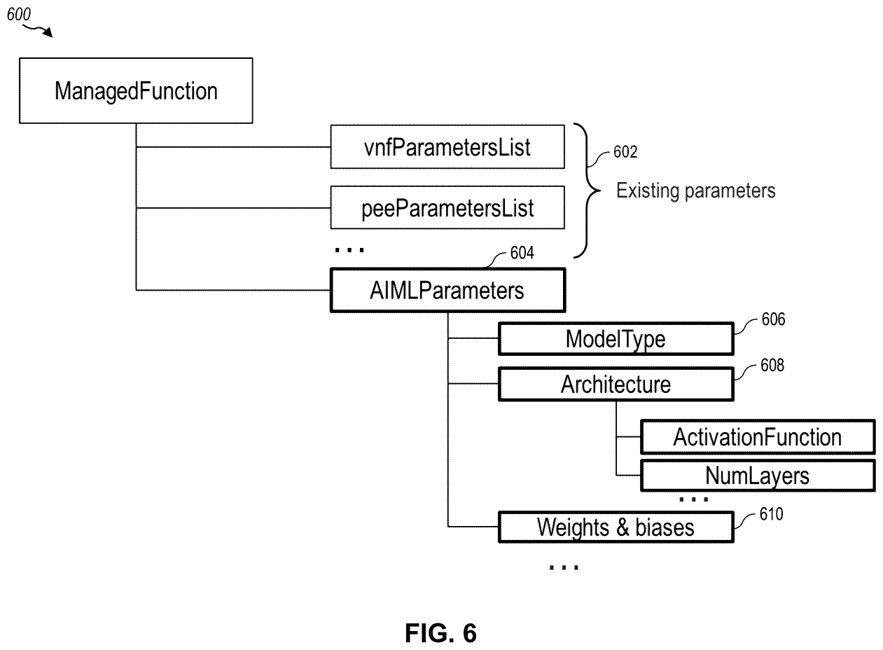

In some examples, the at least one AI/ML configuration parameter may include multiple AI/ML parameters in the configuration data model. FIG. 6 illustrates a block diagram showing AI/ML configuration parameters with existing parameters in a configuration data model according to aspects of this disclosure. For example, the configuration data model 600 as a network resource model may include existing parameters 602 (e.g., virtualized network function parameters) and AI/ML configuration parameters 604. In some examples, the AI/ML configuration parameters 604 may define the AI/ML model and how the AI/ML model should be performed. For example, the AI/ML configuration parameters 604 may include a model type parameter, an architecture parameter, a weights and biases parameter, and/or a metadata parameter. For example, the model type parameter 606 may include a deep neural network (e.g., Multi-Layer Perceptrons (MLP), Convolutional Neural Network (CNN), Recurrent Neural Network (RNN), and/or any other suitable neural network), a transformer (e.g., an auto-regressive model, an auto-encoding model, a sequence-to-sequence model, and/or any other suitable transformer), a random forest, a linear regression, and/or any other suitable model. In some examples, the architecture parameter 608 for a DNN may include a number of layers, a number of nodes, a connection between layers, an activation function, and/or any other suitable architecture related parameter. The weights and biases parameter 610 may include parameters that define edge weights and bias applied to each node. The metadata parameter may include a software dependency, a model identifier, a model name, a model version, a description, a dataset used for training, a loss function, accuracy, a hyperparameter, and/or any other suitable metadata.

The AI/ML model 508 may be deployed in the NF 410. In some examples, a software package implementing the NF 410 may include the AI/ML model 508. In other examples, the AI/ML model 508 may be in the same cloud server as the NF 410. In further examples, the AI/ML model 508 may be in the different cloud server from the NF 410 but be logically coupled to the NF 410. The AI/ML model 508 may include multiple layers with weights to calculate correlations between the input data and the output data. The AI/ML model 508 may have different architectures (e.g., number of layers, type of layers, ordering of layers, connections between layers, hyperparameters for layers) to improve communications in the network. In some configurations, the AI/ML model may be structured as a single-layer perceptron network, in which a single layer of output nodes is used, and inputs are fed directly to the outputs by a series of weights. In other configurations, the AI/ML model can be structured as multilayer perceptron networks, in which the inputs are fed to one or more hidden layers before connecting to the output layer. As one example, the AI/ML model may be configured as a feedforward network, in which the connections between nodes do not form any loops in the network. As another example, the AI/ML model may be configured as an RNN, in which connections between nodes are configured to allow for previous outputs to be used as inputs while having one or more hidden states, which in some instances may be referred to as a memory of the RNN. RNNs are advantageous for processing time-series or sequential data. Examples of RNNs include long-short term memory (LSTM) networks, networks based on or using gated recurrent units (GRUs), or the like.

The AI/ML model 508 may be structured with different connections between layers. In some instances, the layers are fully connected, in which each all of the inputs in one layer are connected to each of the outputs of the previous layer. Additionally or alternatively, neural networks can be structured with trimmed connectivity between some or all layers, such as by using skip connections, dropouts, or the like. In skip connections, the output from one layer jumps forward two or more layers in addition to, or in lieu of, being input to the next layer in the network. An example class of the AI/ML model that implement skip connections includes residual neural networks, such as ResNet. In a dropout layer, nodes are randomly dropped out (e.g., by not passing their output on to the next layer) according to a predetermined dropout rate. In some embodiments, the AI/ML model may be configured as a CNN, in which the network architecture includes one or more convolutional layers. Additionally or alternatively, the AI/ML model may use supervised learning or unsupervised learning to be configured as a trained model. The AI/ML model is not limited to the models described above, but any other suitable AI/ML model can be used to improve communications in the network.

The AI/ML model 508 may be updated based on the at least one AI/ML configuration parameter 604. For example, updating the AI/ML model 508 may include applying the at least one AI/ML configuration parameter 604 to the AI/ML model 508. The AI/ML model 508 may be an existing AI/ML model or a new AI/ML model. In some examples, the AI/ML model 508 may be updated using an online model update. In such examples, the AI/ML model configuration is updated without stopping or restarting the system which performs AI/ML inference. In other examples, the AI/ML model 508 may be updated using an offline model update. For example, the software running (executing) model inference may be updated and restarted to perform inference using the new model parameters. In further examples, the AI/ML model 508 may be updated using a model serving platform. In such examples, the AI/ML model 508 may be updated on a model serving platform, which is separate from the system including the SMO framework 360.

In further examples, the configuration data model may include at least one NF configuration parameter. The NF 410 may be controlled based on the at least one NF configuration parameter. In some examples, different access control can be granted per AI/ML model. For example, only certain entities may be allowed to update a model (e.g., the vendor that developed the model for the NF or the NF vendor).

Referring again to FIG. 5, the fault data model 506 may include at least one AI/ML fault indication. For example, the fault data model 506 may include at least one AI/ML fault field to include the at least one AI/ML fault indication. In some examples, the at least one AI/ML fault field may be added to the existing fault data model. In some examples, the NF 410 and/or the AI/ML model 508 may determine the AI/ML fault indication. For example, the AI/ML fault indication may include an AI/ML software error (e.g., AI/ML software crash), no inference generated (e.g., no software error, but inference not generated), an inference latency being longer than a threshold, and/or any other suitable fault indication.

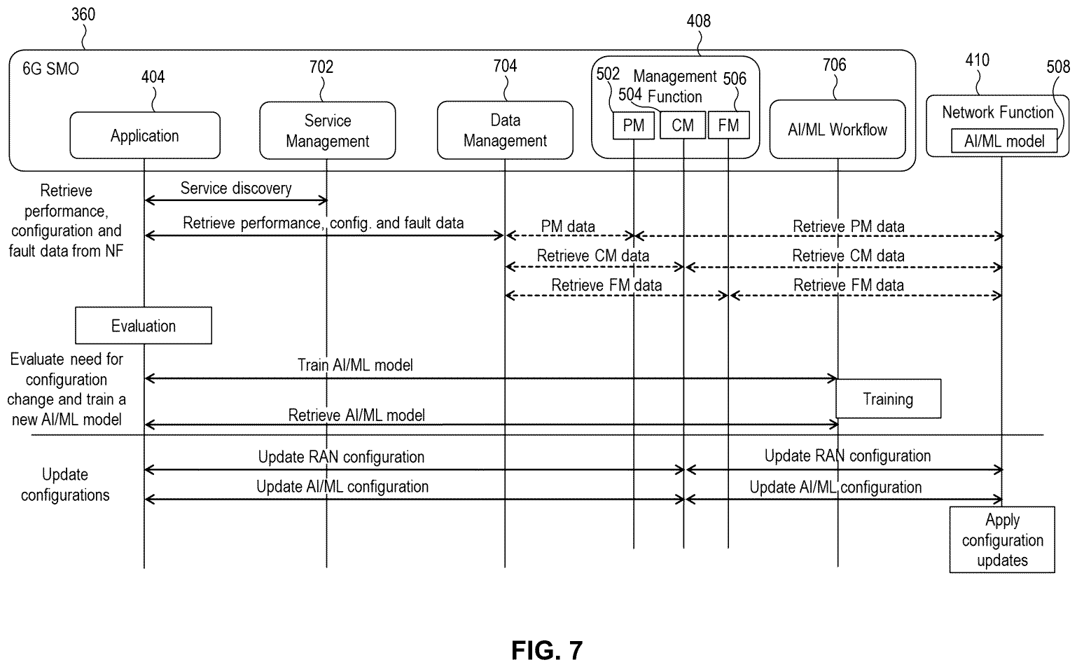

FIG. 7 is a sequence diagram to show management of an AI/ML model deployed in an NF using an SMO framework according to aspects of this disclosure. For example, the SMO framework 360 may train the AI/ML model and update the network and/or AI/ML configurations.

In some examples, an application 404 in the SMO framework 360 may manage the lifecycle of the AI/ML model 508 deployed in the NF 410. To manage the lifecycle of the AI/ML model 508, the application 404 may interact with a service management component 702, a data management component 704, the management function 408, and/or an AI/ML workflow component 706 in the SMO framework 360. For example, the application 404 may discover a service to be fulfilled using the AI/ML model 508. In some examples, the application 404 may perform the service discovery through the service registry in the service management component 702 in the SMO framework 360. For example, the application 404 in the SMO framework 360 may transmit a service discovery request to the service management 702 in the SMO framework 360. Then, the service management component 702 may identify the service using the AI/ML model 508 in the service registry and transmit a service discovery response to the application 404. It should be noted that the service registry allows for registration and discovery of various services, not limited to those directly using AI/ML models. When a service is registered, it includes information such as the service name, description, version, owner/vendor, and other relevant metadata. This information may or may not explicitly include details about AI/ML models used by the service. For instance, a service providing user location might employ ML methods to improve accuracy, but this implementation detail may not necessarily be exposed to other services. The service registry also accommodates the registration and discovery of management services. An application, acting as a service consumer, can discover these management services—for example, a configuration management service. The name or metadata of such a service can specify that it is designed for managing RAN network functions. The consumer can use this information to select the appropriate service for managing RAN NFs. In the context of AI/ML management, the service discovery process would typically involve identifying services that manage AI/ML capabilities of NFs, rather than just services that use AI/ML models. This approach allows for more flexible and granular management of AI/ML functionalities within the network infrastructure. In some examples, for the service discovery, the SMO framework 360 may register the service using the AI/ML model or the management function 408 in the service registry to be discovered by a service consumer. In such examples, the network node may manage authorization of the service consumer to access the AI/ML related data model or the service. In some examples, for the service discovery, the SMO framework 360 may register the service using the AI/ML model or the management function 408 in the service registry to be discovered by a service consumer. In such examples, the network node may manage authorization of the service consumer to access the AI/ML related data model or the service.

After the service discovery, the application 404 may retrieve performance, configuration and/or fault data using the data management component 704 in the SMO framework 360. For example, the application may transmit a request to the data management component 704 to retrieve at least one AI/ML performance measurement indication, at least one AI/ML configuration parameter, and/or at least one AI/ML fault indication from the data management component 704. In some examples, the data management component 704 may retrieve the at least one AI/ML performance measurement indication, the at least one AI/ML configuration parameter, and/or the at least one AI/ML fault indication from the memory 242. In some examples, the memory 242 may already include the at least one AI/ML performance measurement indication, the at least one AI/ML configuration parameter, and/or the at least one AI/ML fault indication due to a previous request or any other request from the application 404 or any other application. In such examples, the data management component 704 may retrieve the data, which is available in the memory 242, and does not additionally retrieve the data from the NF 410 and/or the AI/ML model 508. In other examples, the data management component 704 may request data to the NF 410 and/or the AI/ML model 508 when the data management component 704 receives a request from the application 404. For example, the data management component 704 may not find the data in the memory 242 or may periodically retrieve the data from the NF 410 and/or the AI/ML model 508. In such examples, the data management component 704 may request the NF 410 and/or the AI/ML model 508 to retrieve the at least one AI/ML performance measurement indication, the at least one AI/ML configuration parameter, and/or the at least one AI/ML fault indication using the management function 408.

The management function 408 may include the performance management 502, the configuration management 504, and/or the fault management 506. For example, the management function 408 may include an API to request performance measurement data, the configuration data, and/or the fault data from the NF 410 and/or the AI/ML model 508. In some examples, the management function may receive a request from the data management component 704 and call an API using the AI/ML performance data model described in FIG. 5, the AI/ML configuration data model described in FIG. 6, and/or AI/ML fault data model described in FIG. 5 to retrieve the at least one AI/ML performance measurement indication, the at least one AI/ML configuration parameter, and/or the at least one AI/ML fault indication. In some examples, the management function 408 may include the existing API, which is defined for accessing or providing non-AI/ML data, to retrieve the AI/ML related data from the NF 410 and/or the AI/ML model 508. Additionally or alternatively, the management function 408 may include the same API or different APIs to retrieve the at least one AI/ML configuration parameter, and/or the at least one AI/ML fault indication from the NF 410 and/or the AI/ML model 508. For example, the management function 408 may include a performance measurement API to retrieve the AI/ML performance measurement indication from the NF 410 and/or the AI/ML model 508. The management function 408 may include a configuration API to retrieve the AI/ML configuration parameters from the NF 410 and/or the AI/ML model 508. The management function 408 may include a fault API to retrieve the AI/ML fault indication from the NF 410 and/or the AI/ML model 508. Then, the NF 410 may transmit the at least one AI/ML configuration parameter, and/or the at least one AI/ML fault indication to the management function 408. The management function 408 may provide the data to the application 404 via the data management component 704.

After the application retrieves the performance, configuration, and/or fault data from the NF 410, the application may evaluate the retrieved data to determine whether the AI/ML model 508 deployed in the NF 410 is in need to be retrained. For example, the application 404 may determine that the accuracy of the AI/ML model 508 is lower than a threshold and determine to update the AI/ML model 508.

To update the AI/ML model 508, the SMO framework may train a new AI/ML model. For example, the application 404 may transmit a request to train an AI/ML model to the AI/ML workflow component 706. In some examples, the request may include at least part of the AI/ML configuration parameters (e.g., the model type parameter 606, the architecture parameters 608 in FIG. 6). The AI/ML workflow component 706 may train an AI/ML model using training data and the request from the application 404 to provide the trained AI/ML model to the application. In some examples, the training data may include the retrieved performance, the retrieved fault data, the network traffic data, and/or any other suitable data. The model type parameter 606 and the architecture parameters 608 may be the same as the AI/ML model 508 deployed in the NF 410 or may be different from the AI/ML model 508 deployed in the NF 410. In other examples, the request may not include the AI/ML configuration parameters. In such examples, the AI/ML workflow component 706 may retrain the AI/ML model, which is the same model as the AI/ML model 508 deployed in the NF 410. During the training, the weights and/or biases of the AI/ML model may be updated. The application 404 may retrieve the trained AI/ML model.

The training process of the AI/ML model typically involves supervised learning, where the input to machine learning training is a set of input and output data (ground truth). Through this training, the AI/ML model learns to estimate output based on input. The performance of the model is determined by how closely the generated output matches the ground truth. The specific input and output data depend on the particular problem being addressed. In the wireless domain, for example, one application might be predicting traffic demand on a sector level one minute in advance. In this case, input parameters could include current and past traffic demand in the sector of interest, data from neighboring sectors, user mobility information, and other relevant factors. Re-training of the model may be necessary due to changes in the environment. For instance, changes in user mobility patterns resulting from the construction of a new road, repairs on existing roads, or unexpected events such as natural disasters could necessitate model re-training. Before initiating the re-training process, a new set of data is required. This new dataset could incorporate data from existing sets or consist entirely of new data. To facilitate this, machine learning systems often store such data (both input and ground truth, when possible) on a regular basis, ensuring that a suitable dataset is available when model re-training becomes necessary. This additional text provides a more detailed explanation of the AI/ML model training process, including examples relevant to wireless networks and the reasons for potential re-training, as per the inventor's comments.

The application 404 may update the configurations of the network (e.g., the RAN and/or the core network) and the AI/ML model 508. For example, the network configuration may be determined based on the AI/ML associated data (e.g., inference data from the AI/ML model 508, the performance data, the configuration data, the fault data, and/or any other suitable data from the NF 410 and/or the AI/ML model 508). In some examples, the SMO framework 360 may receive network operation information from the NF 410 and may determine the updated network configuration further based on the network operation information. For example, the network operation information may include domain-specific information related to the NF 410 (e.g., RAN performance measurements, configuration, faults, trace, and/or any other suitable information).

The application 404 may transmit an updated network configuration to the management function 408 to call an API to transmit the updated network configuration to the NF 410. Similarly, the application 404 may transmit an updated AI/ML configuration to the management function 408 to call an API to transmit the updated network configuration to the NF 410. In some examples, the management function 408 may use the same configuration management to transmit the updated network configuration and the AI/ML configuration to the NF 410. In some examples, the application 404 may determine the updated network configuration using the performance measurement data, configuration data, fault data retrieved from the NF 410 (e.g., using the AI/ML model 508 deployed in the NF 410). In some examples, the SMO framework 360 may transmit an AI/ML configuration and/or a network configuration to the NF 410. In other examples, the SMO framework 360 may transmit an AI/ML configuration and/or a network configuration to multiple NFs to apply the configurations to the NFs.

The network function 410 may apply the updated configurations. For example, the AI/ML model 508 may be updated using an online model update, an offline model update, or a model serving platform as described in FIG. 5. In addition, the NF 410 may control wireless communications based on the updated network configuration. For example, the NF 410 may turn off or on a cell for the wireless communications in the network based on the updated network configuration. In other examples, the NF 410 may turn off or on certain transmit antennas for the wireless communications in the network based on the updated network configuration. Controlling wireless communications is not limited to the examples but may include any other suitable technique.

In such examples, the AI/ML related services may not change the API in the management function and may be compatible with the existing services of the performance management 802, the configuration management 804, and the fault management 806. Thus, the SMO framework may minimize the changes in the architecture while the SMO framework 360 may use AI/ML services of the AI/ML model 508 deployed in the NF 410.

FIG. 8 illustrates a block diagram showing an SMO framework including management services to control a network function and manage an AI/ML model deployed in the SMO framework according to aspects of this disclosure. For example, the management function 408 may include performance management 802 using a performance data model, configuration management 804 using a configuration data model, fault management 806 using a fault data model, and/or AI/ML management 808 using an AI/ML data model. In some example, the performance management 802, the configuration management 804, and the fault management 806 may be similar to the performance management 502, the configuration management 504, and the fault management 506 in FIG. 5, respectively except that the performance management 802, the configuration management 804, and the fault management 806 in FIG. 8 do not include new data models or data fields associated with an AI/ML model 508. The performance management 802, the configuration management 804, and the fault management 806 in FIG. 8 may use existing data models defined by 3GPP or O-RAN. The SMO framework 360 may include a separate management, which is the AI/ML management 808, to manage the AI/ML model 508 deployed in an NF 410. The AI/ML model 508 and the NF 410 are similar to the AI/ML model 508 in FIG. 5 and the NF 410 in FIGS. 4 and 5, respectively.

The AI/ML management 808 may include an interface to communicate with the NF 410. In some examples, the AI/ML management 808 may use various protocols (e.g., REST API, Remote Procedure Call (gRPC), WebSocket, custom application protocol over TCP/IP, message bus for reporting performance measurements, configuration updates, fault notifications by NF). The protocols used in the AI/ML management 808 may provide functionalities. For example, the AI/ML management 808 may configure performance measurements (e.g., which measurements to report, at what frequency), fault notifications (which faults, method for notification), configuration change notifications (e.g., reporting of changes made manually), enable service consumers to receive performance, configuration and fault information, enable service consumers to acknowledge and reset fault notifications, and/or enable service consumers to create, query, modify, delete configuration parameters. In some examples, the interface may limit access to the NF 410 and/or the AI/ML model 508. In some examples, the AI/ML management 808 may control access differently to each AI/ML model. For example, only specific entities may be allowed to update a model (e.g., the vendor that developed the model for the NF or the NF vendor).

The AI/ML management 808 using the AI/ML data model may communicate with the application 404 and the NF 410. For example, the extended information and data models in the performance management 502, the configuration management 504, and the fault management 506 in FIG. 5 may be included in the AI/ML management 808 with the AI/ML data model. For example, the AI/ML data model may include AI/ML model parameters (e.g., weights, biases), AI/ML performance measurement indications (e.g., mean square error, F1-score), and/or AI/ML fault indications (e.g., no inference output, software error). In some examples, the AI/ML management 808 may manage performance, configuration, and fault information related to AI/ML capability. For example, the AI/ML management 308 may use an AI/ML data model, which includes at least one AI/ML configuration parameter, at least one AI/ML performance measurement indication, and at least one AI/ML fault indication. In other examples, the AI/ML management 808 may include separate service managements to manage performance, configuration, and fault information related to AI/ML capability. For example, the AI/ML management 808 may use multiple sub-managements corresponding to at least one AI/ML configuration parameter, at least one AI/ML performance measurement indication, and at least one AI/ML fault indication.

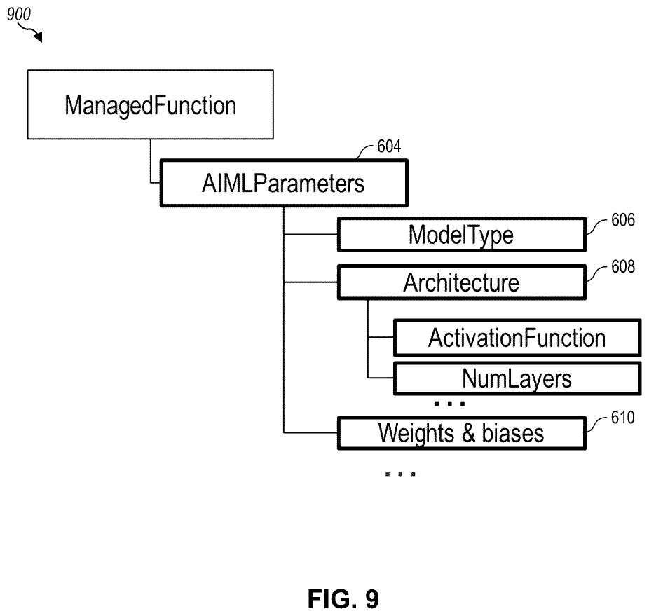

The AI/ML configuration data model may include multiple AI/ML configuration parameters in the configuration data model. FIG. 9 illustrates a block diagram showing AI/ML configuration parameters in a configuration data model according to aspects of this disclosure. For example, the configuration data model 900 as a network resource model may include AI/ML configuration parameters 604. The AI/ML configuration parameters the AI/ML configuration parameters 604 may include a model type parameter 606, an architecture parameter 608, a weights and biases parameter 610, and/or a metadata parameter. The model type parameter 606, the architecture parameter 608, the weights and biases parameter 610, and/or the metadata parameter in FIG. 9 are similar to the model type parameter 606, the architecture parameter 608, the weights and biases parameter 610, and/or the metadata parameter in FIG. 6.

The data model may include a performance data model that includes at least one AI/ML performance measurement indication. The performance data model is similar to the performance data model in FIG. 5. Additionally or alternatively, the data model may include a fault data model that includes at least one AI/ML fault indication. The fault data model is similar to the fault data model in FIG. 5.

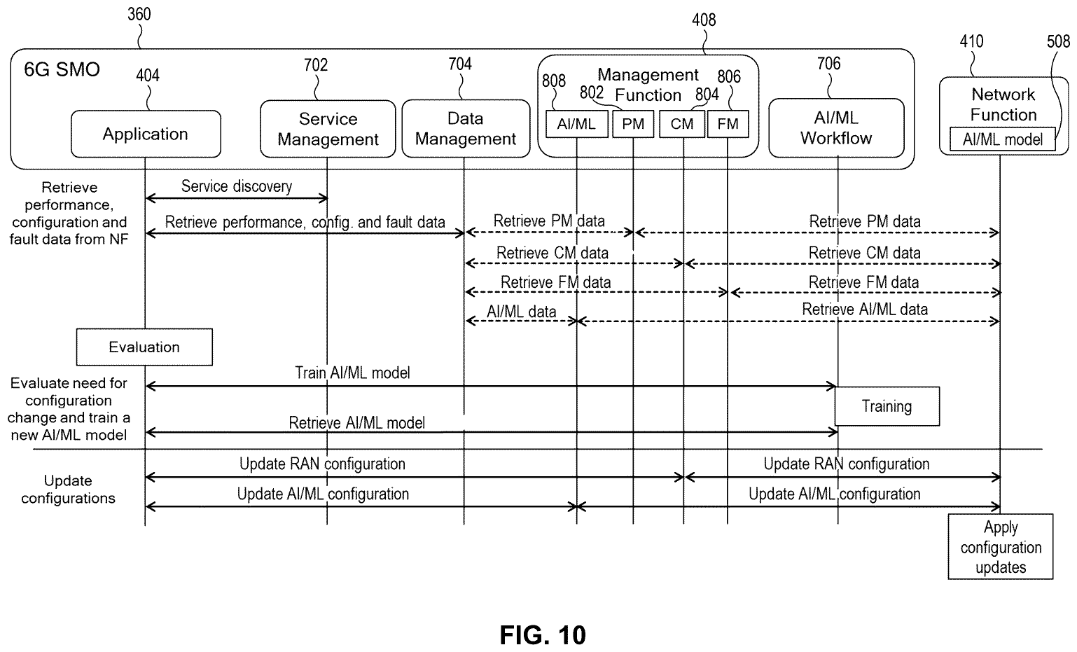

FIG. 10 is a sequence diagram to show management of an AI/ML model deployed in an NF using an SMO framework according to aspects of this disclosure. The SMO framework 360 may communicate with an NF 410 and/or an AI/ML model 508 and manage the lifecycle of the AI/ML model 508. The SMO framework 360 may include an application 404, a service management component 702, a data management component 704, a management function 408, and/or an AI/ML workflow component 706. The application 404, the service management component 702, the data management component 704, and the AI/ML workflow component 706 in FIG. 10 are similar to the application 404, the service management component 702, the data management component 704, and the AI/ML workflow component 706 in FIG. 7.

The application 404 may discover a service to be fulfilled using the AI/ML model 508. The service discovery of the application 404 is similar to the service discovery in FIG. 7. After the service discovery, the application 404 may retrieve performance, configuration and/or fault data using the data management component 704 in the SMO framework 360. In some examples, the request to retrieve the data from the data management component 704 is similar to the request to retrieve the data from the data management component 704 in FIG. 7.

In some examples, the data management component 704 may not find the data in the memory 242 or may periodically retrieve the data from the NF 410 and/or the AI/ML model 508. In such examples, the data management component 704 may request the NF 410 and/or the AI/ML model 508 to retrieve the at least one AI/ML performance measurement indication, the at least one AI/ML configuration parameter, and/or the at least one AI/ML fault indication using the management function 408.

The management function 408 may include the performance management 802, the configuration management 804, the fault management 806, and/or the AI/ML management 808. The performance management 802, the configuration management 804, and the fault management 806 may retrieve at least one performance measurement indication, at least one configuration parameter, and at least one fault indication associated with the network from the network function 410. The AI/ML management 808 may retrieve at least one AI/ML performance measurement indication, at least one AI/ML configuration parameter, and at least one AI/ML fault indication. In some examples, the AI/ML management 808 may include an API to request AI/ML performance measurement data, AI/ML configuration data, and/or AI/ML fault data from the NF 410 and/or the AI/ML model 508. In some examples, the AI/ML management 808 may receive a request from the data management component 704 and call an API using the AI/ML performance data model described in FIG. 8, the AI/ML configuration data model described in FIG. 9, and/or AI/ML fault data model described in FIG. 8 to retrieve the at least one AI/ML performance measurement indication, the at least one AI/ML configuration parameter, and/or the at least one AI/ML fault indication. In some examples, the AI/ML management 808 may retrieve the AI/ML performance measurement data, the AI/ML configuration data, and/or the AI/ML fault data using one or more APIs. In other examples, the AI/ML management 808 may include multiple sub-managements corresponding to the AI/ML performance measurement data, the AI/ML configuration data, and/or the AI/ML fault data. In such examples, a first sub-management of the AI/ML management 808 may retrieve the AI/ML performance measurement data, a second sub-management of the AI/ML management 808 may retrieve the AI/ML configuration data, and a third sub-management of the AI/ML management 808 may retrieve the AI/ML fault data. The second sub-management may manage the AI/ML model 508 by updating the AI/ML configuration parameters in the AI/ML model 508 deployed in the NF 410.

After the application retrieves the performance, configuration, and/or fault data from the NF 410, the application may evaluate the retrieved data. The evaluation of the retrieved data is similar to the evaluation of FIG. 7. Based on the evaluation, the SMO framework 360 may train an AI/ML model via the AI/ML workflow component 706. The training of the AI/ML model is similar to the training and retrieving the AI/ML model in FIG. 7. Then, the application 404 may retrieve the trained AI/ML model.

The application 404 may update the configurations of the network (e.g., the RAN and/or the core network) and the AI/ML model 508. The configuration update of the network is similar to the configuration update in FIG. 7. In some examples, the application 404 may transmit an updated AI/ML configuration to the AI/ML management 808 in the management function 408 to call an API to transmit the updated network configuration to the NF 410. Thus, the application may utilize the configuration management 804 to update the network configuration and use the AI/ML management 808 to update the AI/ML configuration parameters.

The network function 410 may apply the updated configurations. For example, the AI/ML model 508 may be updated using an online model update, an offline model update, or a model serving platform as described in FIG. 5. In addition, the NF 410 may control wireless communications based on the updated network configuration.

In such examples, the AI/ML management 808 is a new service in the SMO framework 360. The new service with new data model in the SMO framework may be flexible such that any other new capability of the AI/ML management 808 can be added or an existing capability can be revised without affecting the existing services of the performance management 802, the configuration management 804, and the fault management 806.

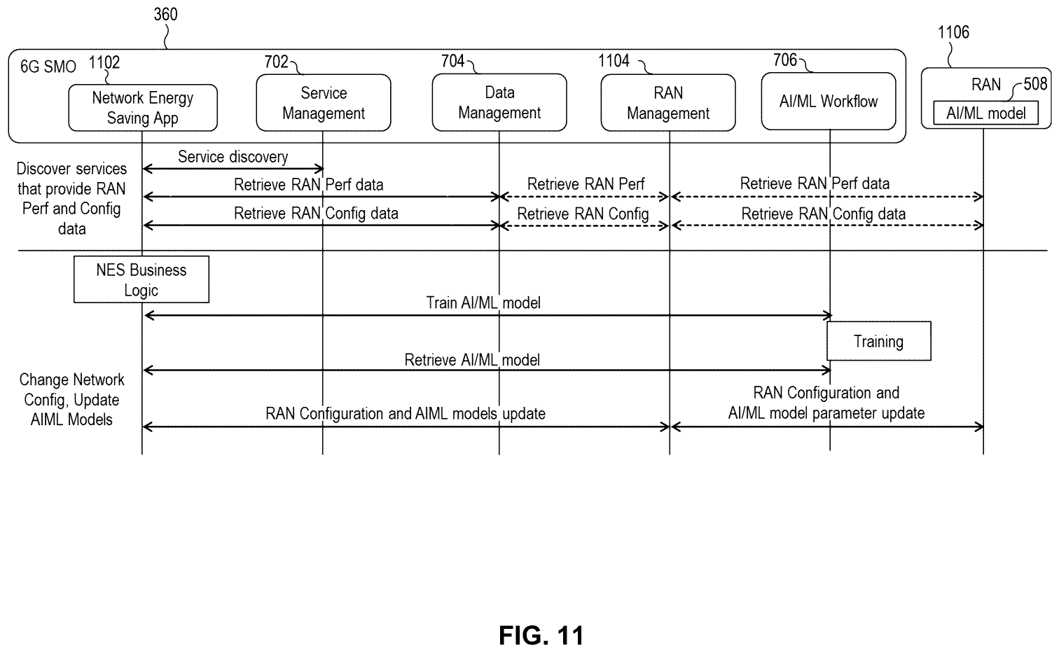

FIG. 11 is a sequence diagram to show management of an AI/ML model deployed in an NF using a network energy saving application of an SMO framework according to aspects of this disclosure. For example, the SMO framework 360 may include a network energy saving application 1102. The network energy saving application 1102 may perform the service discovery by communicating with the service management component 702 in the SMO framework 360. Then, the network energy saving application 1102 may retrieve RAN performance data and/or RAN configuration data from the data management component 704 in the SMO framework 360. When the RAN performance data and/or the RAN configuration data are not available, the data management component 704 may retrieve the RAN performance data and/or the RAN configuration data from a RAN 1106 via a RAN management. In some examples, the RAN 1106 and the RAN management 1104 may correspond to the NF 410 and the management function 408 of FIGS. 4, 7, and 10. After the network energy saving application 1102 retrieves the RAN performance data and/or the RAN configuration data, the network energy saving application 1102 may determine to retrain the AI/ML model 508 deployed in the RAN 1106 using the network energy determination logic. When the network energy saving application 1102 determines to retrain the AI/ML model 508, the network energy saving application 1102 may train and retrieve an AI/ML model via the AI/ML workflow component 706 in the SMO framework. Then, the network energy saving application 1102 may update the RAN configuration and AI/ML model configuration based on the retrieved AI/ML model 508. The updated RAN configuration and AI/ML model configuration may be transmitted via the RAN management 1104 and be applied to the RAN 1160 and the AI/ML model 508.

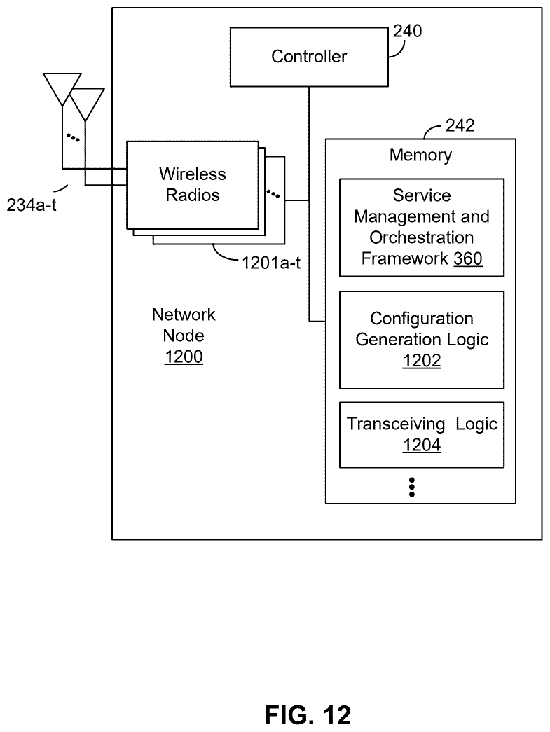

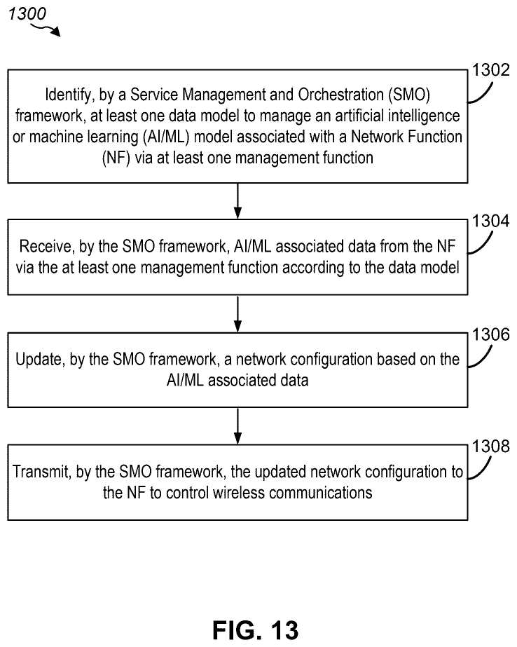

FIG. 12 is a block diagram of an example network node 1200 that SMO framework configuration for AI/ML model management according to one or more aspects. The network node 1200 may be configured to perform operations, including the blocks of the process 1300 described with reference to FIG. 13, respectively. In some implementations, the network node 1200 includes the one or more chips, SoCs, chipsets, packages, structure, hardware, and components shown and described with reference to the network node 105 of FIGS. 1-3. Additionally or alternatively, the network node 1200 may be included in the central server, the telco edge cloud server, and/or the cell site edge server. For example, the network node 1200 may include the controller 240, which operates to execute logic or computer instructions stored in the memory 242, as well as controlling the components of the network node 1200 that provide the features and functionality of the network node 1200. The network node 1200, under control of the controller 240, transmits and receives signals via wireless radios 1201a-t and the antennas 234a-t. The wireless radios 1201a-t include various components and hardware, as illustrated in FIG. 2 for the network node 105, including the modulator and demodulators 232a-t, the transmit processor 220, the TX MIMO processor 230, the MIMO detector 236, and the receive processor 238.

As shown, the memory 242 may include an SMO framework 360 in FIG. 3, a configuration generation logic 1204, and a transceiving logic 1206. The SMO framework 360 may the application 404 in FIG. 4, the network energy saving application 1202 in FIG. 12, the service management component 902 in FIG. 9, the data management component 1102 in FIG. 11, and/or the AI/ML workflow management 502 in FIG. 5. The SMO framework 360 may be deployed in one network node 1200, a central server, a telco edge server, and/or a cell site edge server. In some examples, the SMO framework 360 may also include a hardware component (e.g., controller 240 and/or wireless radios 1201a-t). The configuration generation logic 1202 may configure and orchestrate the SMO framework 360 to communicate with external entity and use external functionalities. The transceiving logic 1204 of the network node 1200 may be configured to transmit signals (e.g., receiving AI/ML associated data, transmitting an updated network configuration, and/or transmitting or receiving any other suitable signals) to one or more entities (e.g., the NF 410 in FIG. 4 and/or the RAN 1106 in FIG. 11).

In some implementations, the network node 1200 may be configured to perform the process 1300 of FIG. 13. To illustrate, the network node 1200 may execute, under control of the controller 240 (e.g., RIC), the configuration generation logic 1202 and the transceiving logic 1204 stored in the memory 242. The execution environment of the configuration generation logic 1202 provides the functionality to perform at least the operations in block 1302. The execution environment of the transceiving logic 1204 provides the functionality to perform at least the operations in blocks 1302 and 1304 in FIG. 13.

FIG. 13 illustrates a method 1300 for wireless communication at a network node according to aspects of this disclosure. According to some aspects, the network node is a network node is a network entity, such as a base station as described in any of FIGS. 1-3 and the network node 1200 in FIG. 12.

At step 1302, the network node identifies, by an SMO framework, at least one data model to manage an AI/ML model associated with an NF via at least one management function. In some examples, the network node may register the at least one management function associated with the AI/ML model in a service registry of the SMO framework to be discovered by a service consumer. In such examples, the network node may manage authorization of the service consumer to access the at least one data model. The service registration and discovery are described in connection with FIGS. 7, 10, and 11.

In some examples, the at least one data model may include at least one of a configuration data model, a performance data model, or a fault data model. The configuration data model may include at least one AI/ML configuration parameter. The performance data model may include at least one AI/ML performance measurement indication. The fault data model may include at least one AI/ML fault indication. The configuration data model including the at least one AI/ML configuration parameter, the performance data model including the at least one AI/ML performance measurement indication, and the fault data model including the at least one AI/ML fault parameter are described in connection with FIGS. 5-7.

In other examples, the at least one data model may include an AI/ML data model. The AI/ML data model may include at least one AI/ML configuration parameter, at least one AI/ML performance measurement indication, and at least one AI/ML fault indication. The AI/ML data model including the at least one AI/ML configuration parameter, the at least one AI/ML performance measurement indication, and the at least one AI/ML fault parameter are described in connection with FIGS. 5-7.

In some scenarios, the at least one management function comprises a management function to use the at least one AI/ML configuration parameter, the at least one AI/ML performance measurement indication, and the at least one AI/ML fault indication. In other scenarios, the at least one management function comprises a plurality of management functions corresponding to the at least one AI/ML configuration parameter, the at least one AI/ML performance measurement indication, and the at least one AI/ML fault indication. The at least one management function may include at least one of: the management function 408, the performance management 502 in FIGS. 5-7, the configuration management 504 in FIGS. 5-7, the fault management 506 in FIGS. 5-7, the management function 408, the performance management 802 in FIGS. 8-10, the configuration management 804 in FIGS. 8-10, or the fault management 806 in FIGS. 8-10. In some examples, the NF may be a first network function of a RAN or a second network function of a core network. The NF is described in connection with FIG. 4.

At step 1304, the network node receives, by the SMO framework, AI/ML associated data from the NF via the at least one management function according to the data model. In some examples, receiving the AI/ML associated data may include retrieving at least one of: the at least one AI/ML performance measurement indication, the at least one AI/ML configuration parameter, or the at least one AI/ML fault indication from the NF in FIGS. 5-11.

At step 1306, the network node updates, by the SMO framework, a network configuration based on the AI/ML associated data. The updating of the network configuration is described in connection with FIGS. 7, 10, and 11. In some examples, the network node may update the at least one AI/ML configuration parameter based on the AI/ML associated data. The updating of the at least one AI/ML configuration parameter is described in connection with FIGS. 7, 10, and 11. For example, to update the at least one AI/ML configuration parameter, the network node may train a second AI/ML model associated with the AI/ML model, re-training the AI/ML model, or using a different trained version of the AI/ML model based on the AI/ML associated data to determine the updated network configuration associated with the AI/ML model. The training of the AI/ML model is described in connection with FIGS. 7, 10, and 11. In some scenarios, the network node may receive network operation information from the NF and may determine the updated network configuration further based on the network operation information. The determination of the updated network configuration is described in connection with FIGS. 7, 10, and 11.

At step 1308, the network node transmits, by the SMO framework, the updated network configuration to the NF to control wireless communications. In some examples, the NF may include a physical network function. In such examples, the updated network configuration may be transmitted using an adapter in the SMO framework. In some examples, the network node may transmit the at least one AI/ML configuration parameter to the NF to apply the at least one AI/ML configuration parameter to the AI/ML model using an online model update, an offline model update, or an external framework. The transmission of the updated network configuration and/or the at least one AI/ML configuration parameter are described in connection with FIGS. 7, 10, and 11.

Implementation examples are described in the following numbered clauses:

Implementation examples are described in the following numbered clauses:

Clause 1: A method for wireless communication, comprising: identifying, by a Service Management and Orchestration (SMO) framework, at least one data model to manage an artificial intelligence or machine learning (AI/ML) model associated with a Network Function (NF) via at least one management function; receiving, by the SMO framework, AI/ML associated data from the NF via the at least one management function according to the data model; updating, by the SMO framework, a network configuration based on the AI/ML associated data; and transmitting, by the SMO framework, the updated network configuration to the NF to control wireless communications.

Clause 2: The method of Clause 1, wherein the at least one data model comprises at least one of a configuration data model, a performance data model, and a fault data model, wherein the configuration data model comprises at least one AI/ML configuration parameter, wherein the performance data model comprises at least one AI/ML performance measurement indication, and wherein the fault data model comprises at least one AI/ML fault indication.

Clause 3: The method of Clause 2, further comprising: updating the at least one AI/ML configuration parameter based on the AI/ML associated data; and transmitting the at least one AI/ML configuration parameter to the NF to apply the at least one AI/ML configuration parameter to the AI/ML model using an online model update, an offline model update, or an external framework.

Clause 4: The method of Clause 1, wherein the at least one data model comprises an AI/ML data model, and wherein the AI/ML data model comprises at least one AI/ML configuration parameter, at least one AI/ML performance measurement indication, and at least one AI/ML fault indication.

Clause 5: The method of Clause 4, wherein the at least one management function comprises a management function to use the at least one AI/ML configuration parameter, the at least one AI/ML performance measurement indication, and the at least one AI/ML fault indication.

Clause 6: The method of Clause 4, wherein the at least one management function comprises a plurality of management functions corresponding to the at least one AI/ML configuration parameter, the at least one AI/ML performance measurement indication, and the at least one AI/ML fault indication.

Clause 7: The method of Clause 1, further comprising: receiving network operation information from the NF, wherein the updated network configuration is further determined based on the network operation information.

Clause 8: The method of Clause 1, further comprising: training a second AI/ML model associated with the AI/ML model, re-training the AI/ML model, or using a different trained version of the AI/ML model based on the AI/ML associated data to determine the updated network configuration associated with the AI/ML model.

Clause 9: The method of Clause 1, further comprising: registering the at least one management function associated with the AI/ML model in a service registry of the SMO framework to be discovered by a service consumer.

Clause 10: The method of Clause 9, further comprising: managing authorization of the service consumer to access the at least one data model.

Clause 11: The method of Clause 1, wherein the NF comprises a physical network function, and wherein transmitting the updated network configuration using an adapter in the SMO framework.

Clause 12: The method of Clause 1, wherein the NF is a first network function of a radio access network (RAN) or a second network function of a core network.

Clause 13: An apparatus configured to operate as a Service Management and Orchestration (SMO) framework, the apparatus comprising: at least one processor to configure the SMO framework to perform operations comprising: identifying, by a Service Management and Orchestration (SMO) framework, at least one data model to manage an artificial intelligence or machine learning (AI/ML) model associated with a Network Function (NF) via at least one management function; receiving, by the SMO framework, AI/ML associated data from the NF via the at least one management function according to the data model; updating a network configuration based on the AI/ML associated data; and transmitting the updated network configuration to the NF to control wireless communications.

Clause 14: The apparatus of Clause 13, wherein the at least one data model comprises at least one of a configuration data model, a performance data model, or a fault data model, wherein the configuration data model comprises at least one AI/ML configuration parameter, wherein the performance data model comprises at least one AI/ML performance measurement indication, and wherein the fault data model comprises at least one AI/ML fault indication.

Clause 15: The apparatus of Clause 14, wherein the operations further comprise: updating the at least one AI/ML configuration parameter based on the AI/ML associated data; and transmitting the at least one AI/ML configuration parameter to the NF to apply the at least one AI/ML configuration parameter to the AI/ML model using an online model update, an offline model update, or an external framework.

Clause 16: The apparatus of Clause 13, wherein the at least one data model comprises an AI/ML data model, and wherein the AI/ML data model comprises at least one AI/ML configuration parameter, at least one AI/ML performance measurement indication, and at least one AI/ML fault indication.

Clause 17: The apparatus of Clause 16, wherein the at least one management function comprises a management function to use the at least one AI/ML configuration parameter, the at least one AI/ML performance measurement indication, and the at least one AI/ML fault indication.

Clause 18: The apparatus of Clause 13, wherein the operations further comprise: receiving network operation information from the NF, wherein the updated network configuration is further determined based on the network operation information.

Clause 19: The apparatus of Clause 13, wherein the operations further comprise: training a second AI/ML model associated with the AI/ML model, re-training the AI/ML model, or using a different trained version of the AI/ML model based on the AI/ML associated data to determine the updated network configuration associated with the AI/ML model.

Clause 20: The apparatus of Clause 13, wherein the operations further comprise: registering the at least one management function associated with the AI/ML model in a service registry of the SMO framework to be discovered by a service consumer; and managing authorization of the service consumer to access the at least one data model.

Clause 21: A computer program product embodied on a computer-readable storage medium comprising code for performing a method in accordance with any combination of Clauses 1-20.

Clause 22: A network node (e.g., a UE), comprising: at least one transceiver; at least one memory comprising instructions; and one or more processors, individually or collectively, configured to cause the network node to perform the method of clauses 1-12.

Clause 22: A network node (e.g., a UE), comprising: at least one transceiver; at least one memory comprising instructions; and one or more processors, individually or collectively, configured to cause the network node to perform the method of clauses 13-20.

In the figures, a single block may be described as performing a function or functions. The function or functions performed by that block may be performed in a single component or across multiple components, or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure. Also, the example devices may include components other than those shown, including well-known components such as a processor, memory, and the like.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, the term “determine” or “selecting” encompasses a wide variety of actions and, therefore, “selecting” can include calculating, computing, processing, deriving, estimating, investigating, looking up (such as via looking up in a table, a database, or another data structure), inferring, ascertaining, or measuring, among other possibilities. Also, “selecting” can include receiving (such as receiving information), accessing (such as accessing data stored in memory) or transmitting (such as transmitting information), among other possibilities. Additionally, “selecting” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A method, comprising:
identifying, by a Service Management and Orchestration (SMO) framework, at least one data model to manage an artificial intelligence or machine learning (AI/ML) model associated with a Network Function (NF) via at least one management function;
receiving, by the SMO framework, AI/ML associated data from the NF via the at least one management function according to the data model;
updating, by the SMO framework, a network configuration based on the AI/ML associated data; and
transmitting, by the SMO framework, the updated network configuration to the NF to control wireless communications.

2. The method of claim 1, wherein the at least one data model comprises at least one of a configuration data model, a performance data model, or a fault data model,
wherein the configuration data model comprises at least one AI/ML configuration parameter,
wherein the performance data model comprises at least one AI/ML performance measurement indication, and
wherein the fault data model comprises at least one AI/ML fault indication.

3. The method of claim 2, further comprising:
updating the at least one AI/ML configuration parameter based on the AI/ML associated data; and
transmitting the at least one AI/ML configuration parameter to the NF to apply the at least one AI/ML configuration parameter to the AI/ML model using an online model update, an offline model update, or an external framework.

4. The method of claim 1, wherein the at least one data model comprises an AI/ML data model, and
wherein the AI/ML data model comprises at least one AI/ML configuration parameter, at least one AI/ML performance measurement indication, and at least one AI/ML fault indication.

5. The method of claim 4, wherein the at least one management function comprises a management function to use the at least one AI/ML configuration parameter, the at least one AI/ML performance measurement indication, and the at least one AI/ML fault indication.

6. The method of claim 4, wherein the at least one management function comprises a plurality of management functions corresponding to the at least one AI/ML configuration parameter, the at least one AI/ML performance measurement indication, and the at least one AI/ML fault indication.

7. The method of claim 1, further comprising:
receiving network operation information from the NF,
wherein the updated network configuration is further determined based on the network operation information.

8. The method of claim 1, further comprising:
training a second AI/ML model associated with the AI/ML model, re-training the AI/ML model, or using a different trained version of the AI/ML model based on the AI/ML associated data to determine the updated network configuration associated with the AI/ML model.

9. The method of claim 1, further comprising:
registering the at least one management function associated with the AI/ML model in a service registry of the SMO framework to be discovered by a service consumer.

10. The method of claim 9, further comprising:
managing authorization of the service consumer to access the at least one data model.

11. The method of claim 1, wherein the NF comprises a physical network function, and
wherein transmitting the updated network configuration using an adapter in the SMO framework.

12. The method of claim 1, wherein the NF is a first network function of a radio access network (RAN) or a second network function of a core network.

13. An apparatus configured to operate as a Service Management and Orchestration (SMO) framework, the apparatus comprising: at least one processor to configure the SMO framework to perform operations comprising:
identifying, by a Service Management and Orchestration (SMO) framework, at least one data model to manage an artificial intelligence or machine learning (AI/ML) model associated with a Network Function (NF) via at least one management function;
receiving, by the SMO framework, AI/ML associated data from the NF via the at least one management function according to the data model;
updating a network configuration based on the AI/ML associated data; and
transmitting the updated network configuration to the NF to control wireless communications.

14. The apparatus of claim 13, wherein the at least one data model comprises at least one of a configuration data model, a performance data model, or a fault data model, wherein the configuration data model comprises at least one AI/ML configuration parameter, wherein the performance data model comprises at least one AI/ML performance measurement indication, and wherein the fault data model comprises at least one AI/ML fault indication.

15. The apparatus of claim 14, wherein the operations further comprise:
updating the at least one AI/ML configuration parameter based on the AI/ML associated data; and
transmitting the at least one AI/ML configuration parameter to the NF to apply the at least one AI/ML configuration parameter to the AI/ML model using an online model update, an offline model update, or an external framework.

16. The apparatus of claim 13, wherein the at least one data model comprises an AI/ML data model, and
wherein the AI/ML data model comprises at least one AI/ML configuration parameter, at least one AI/ML performance measurement indication, and at least one AI/ML fault indication.

17. The apparatus of claim 16, wherein the at least one management function comprises a management function to use the at least one AI/ML configuration parameter, the at least one AI/ML performance measurement indication, and the at least one AI/ML fault indication.

18. The apparatus of claim 13, wherein the operations further comprise:
receiving network operation information from the NF, wherein the updated network configuration is further determined based on the network operation information.

19. The apparatus of claim 13, wherein the operations further comprise:
training a second AI/ML model associated with the AI/ML model, re-training the AI/ML model, or using a different trained version of the AI/ML model based on the AI/ML associated data to determine the updated network configuration associated with the AI/ML model.

20. The apparatus of claim 13, wherein the operations further comprise:
registering the at least one management function associated with the AI/ML model in a service registry of the SMO framework to be discovered by a service consumer; and
managing authorization of the service consumer to access the at least one data model.
